(19) United States
(12) Patent Application Publication
(10) Pub. No.: US 2004/0165746 A1
(43) Pub. Date: Aug. 26, 2004

(54) Loudspeaker

(76) Inventors: Leonhard Kreitmeier, Bogen (DE); Jurgen Ringlstetter, Straubing (DE)

Correspondence Address: Patrick J O'Shea, Samuels Gauthier & Stevens, Suite 3300, 225 Franklin Street, Boston, MA, 02110, US

(21) Appl. No.: 10/475,078

(22) PCT Filed: Apr. 11, 2002
(86) PCT No.: PCT/EP02/04054

(30) Foreign Application Priority Data
Apr. 25, 2001 (DE) 101 20 281.4

(51) Int. Cl. H04R 11/02; H04R 1/00; H04R 9/06

(52) U.S. Cl. 381/398; 381/400; 381/412; 381/423; 381/433

(57) ABSTRACT

A loudspeaker consisting of a diaphragm, a voice coil carrier secured to the diaphragm in a central area, a voice coil wound around said voice coil carrier, a magnetic system inserted into the voice coil carrier and voice coil in a partial or complete manner, a basket supporting the magnet system and enclosing the diaphragm on one face thereof, an elastic bead fastened to the basket and an edge area of the diaphragm, and a centering device attached to the basket and fastened to the diaphragm in a central area, said centering device being provided with an elastic bead that is directly or indirectly fastened to the basket and the diaphragm.

This invention relates to a loudspeaker with a diaphragm that has an edge area and a central area; a voice coil carrier that is fastened to the diaphragm in the central area; a voice coil that is wound around the voice coil carrier; a magnet system into which the voice coil carrier and the voice coil are completely or partially inserted; a basket that encloses one face of the diaphragm and to which the magnet system is fastened; an elastic bead that is fastened on the one hand to the edge area of the diaphragm and on the other hand to the basket; and a centering device that is fastened on the one hand to the central area of the diaphragm and on the other hand to the basket.

Such a loudspeaker is disclosed, for example, by Ivar Veit, Technische Akustik [Industrial Acoustics], second edition 1978, page 91, wherein a centering spider fastened to the basket and diaphragm is provided as a centering device. The current in the voice coil and the magnetic field in the air gap of the magnet system interact with one another in such a way that Lorentz forces occur in the direction of the axis of symmetry. This converts the input voltage on the voice coil into a mechanical motion of the voice coil and accordingly of the diaphragm. The suspension of the oscillating system consisting of bead and centering spider then generates return forces and holds in position the voice coil, which is connected to the radiating diaphragm. Damping then occurs in this oscillating overall system from a suspension consisting electrically of the magnet system and mechanically of the bead and centering spider.

Since the magnetic force and hence the electrical damping are not constant in the operating area of the loudspeaker in standard loudspeakers, there is a resultant excursion-dependent overall damping that becomes weaker at large excursions. Designs that avoid this are large and uneconomical to manufacture because of the large winding widths and strong magnets necessary for the purpose.

For this reason it is necessary to increase the mechanical damping, which results in the variation of overall damping becoming smaller. Added to this is the fact that the material and mode of motion of the centering spider cause it to contribute an insignificant component to overall damping, in particular because of flexing in the edge area and stretching in the principal area.

The goal of the present invention is to describe a loudspeaker in which mechanical damping is increased.

This goal is achieved by a loudspeaker according to claim 1. Refinements and extensions of the concept of the invention are the objects of subclaims.

One advantage of the invention is that high mechanical damping is produced at low cost. Furthermore, a desired damping range can be produced by readily implemented variations in the material and design.

This is achieved in detail by a loudspeaker of the type referred to at the outset by providing an additional elastic bead as a centering device, which is fastened directly or indirectly to the basket and the diaphragm.

At least one of the two beads is preferably made of foam or rubber. The influential components for producing the desired damping in the case of foam beads in particular are the type of material, the density, and the thickness of the bead. For rubber beads, they are the type of material, thickness, and Shore hardness.

It is preferred for the additional bead to be fastened directly or indirectly to the diaphragm and/or the basket by means of a bead mount. The bead mount can be provided by any structure, for example an injection-molded part, a honeycomb structure, a diaphragm, or another shaped part.

Moreover, a support structure can be provided that is placed between the diaphragm and the additional bead and can be connected directly or indirectly to both. Filling or supporting structures serve to stiffen the overall diaphragm or subregions of the diaphragm to suppress certain modes.

Such a support structure, for example, can also be placed between the diaphragm and the bead mount and can be connected to them directly or indirectly.

The support structure in such a case preferably consists essentially of honeycomb material or of foamed material. Besides this, the support structure can also consist of diaphragm material.

The invention is also used in particular in loudspeakers whose diaphragm is of essentially flat design, with the support structure and/or the bead mount equalizing the distance of the two beads from one another in the direction of oscillation of the diaphragm.

Here, an inverse cone diaphragm in particular is used as the support structure.

Besides the one additional bead, a second additional bead can also be provided that is fastened directly or indirectly to the diaphragm and the basket.

It can also be provided that at least one additional bead has a semicircular bend and a flat area, with the thickness of the bead being smaller in the area of the bend than in the flat area.

The support structure can also be designed as a bead mount.

Finally, the magnet system can be arranged so that it is placed on the side of the basket facing the diaphragm. This results in a very compact structure, especially of a flat loudspeaker.

The invention will be explained in further detail below with reference to the embodiments illustrated in the figures, with half of each rotationally symmetrical structure being illustrated in cross section. In detail:

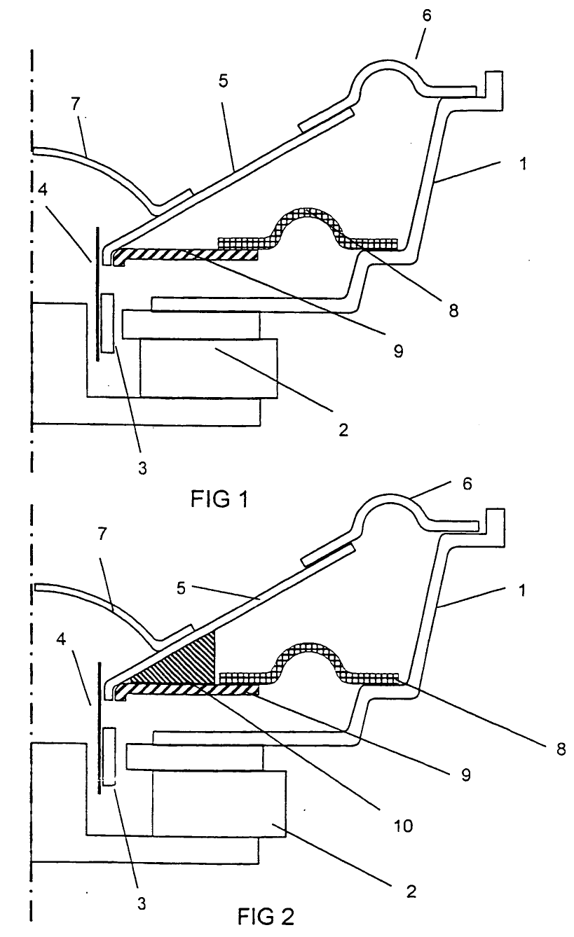

FIG. 1 shows a basic embodiment of a loudspeaker according to the invention;

FIG. 2 shows the loudspeaker according to FIG. 1 with an additional support structure;

FIG. 3 shows an embodiment of a loudspeaker according to the invention with a flat diaphragm;

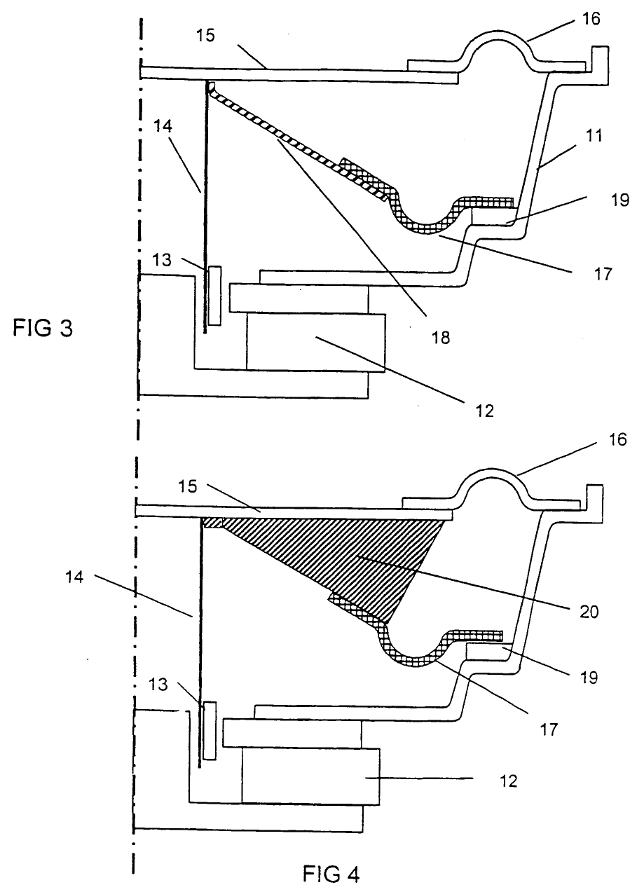

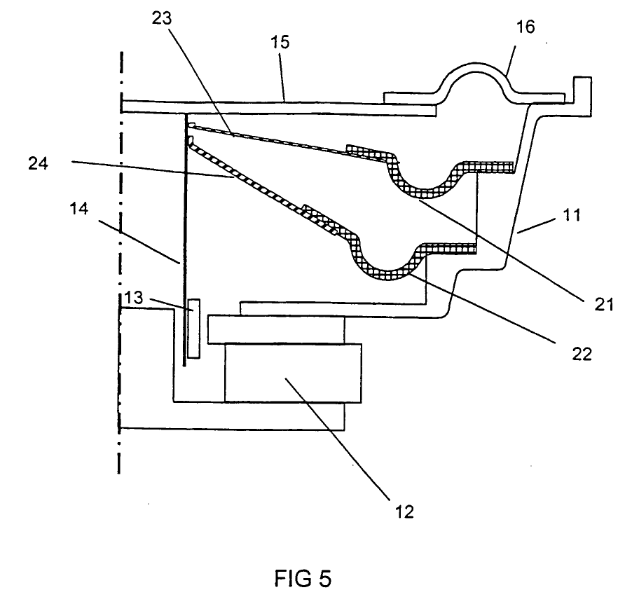

FIG. 4 shows the embodiment according to FIG. 3 with an additional support structure;

FIG. 5 shows an embodiment of a loudspeaker according to the invention with multiple beads;

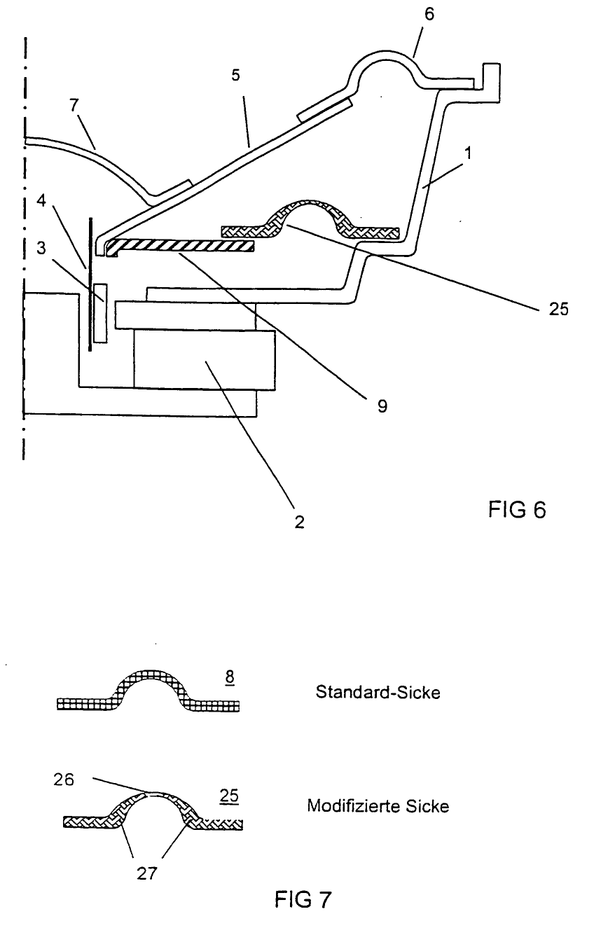

FIG. 6 shows an embodiment of a loudspeaker according to the invention with an optimized shape of the bead with respect to the damping curve over the diaphragm excursion;

FIG. 7 shows the optimized bead according to the sample embodiment of FIG. 6 in detail, by comparison to an ordinary bead; and

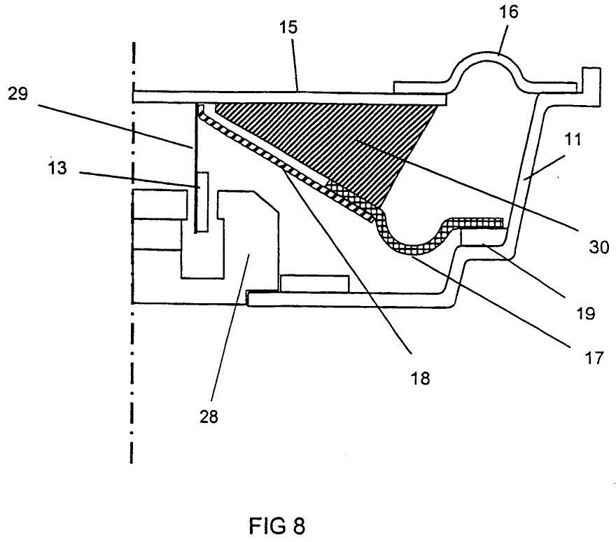

FIG. 8 shows an embodiment of a loudspeaker according to the invention with a raised magnet system.

FIG. 1 shows the cross section of half of a basic embodiment of a loudspeaker according to the invention. There is a funnel-shaped basket 1 as an essential supporting element, into which an opening is made at least in the central area, and to which is fastened a cup-shaped magnet system 2. At a central opening in the basket 1 is placed a voice coil 3 that is movable axially through the opening in the basket into which the magnet system 2 is inserted. The voice coil 3 is wound around a voice coil carrier 4 that in turn is fastened to a diaphragm 5. The diaphragm 5 is fastened by a bead 6 to the outer area of the basket 1 with the capability of vibrating. To protect the drive system consisting of the magnet system 2 and voice coil 3 against penetrating dust, there is a dust guard dome 7 in the area of the connection of the voice coil carrier 4 and the diaphragm 5.

Another bead 8 is then provided according to the invention as a centering device; it is fastened at one end to a corresponding projection of the basket 1 and is connected at the other end through an intermediate bead mount 9 to the central area of the diaphragm 5. With an appropriate design of the additional bead 8, the bead mount 9 could also be dispensed with, but with an identical design of the two beads 6 and 8 by way of example, a bead mount is necessary. Since in contrast to the customary centering diaphragm a bead is not so extended, the bead mount 9 also serves in particular to equalize the distance between the additional bead 8 and the diaphragm 5. The bead mount 9 can be made of any material and in any shape as long as it meets the space requirements and is as light as possible. Therefore, it is preferred to provide a plastic molded part or an additional conforming diaphragm as the bead mount.

The sample embodiment shown in FIG. 2 proceeds from the sample embodiment according to FIG. 1 in that a support structure 10 is provided in addition. The support structure 10 is wedge-shaped and is placed in the angle between the diaphragm 5 and the bead mount 9. It tapers to a point at the seam between the diaphragm 5 and the bead mount 9 and, for example, is cemented firmly to the two. The support structure 10, for example, can also be located in the area of the loudspeaker at which the movable parts of the centering diaphragm were located earlier. The support structure 10 is designed, for example, as a honeycomb structure or as a foamed part.

The embodiment shown in FIG. 3 has a basket 11 with an opening at the central point that is closed off toward the outside by a cup-shaped magnet system. A voice coil 13 that is wound on a voice coil carrier 14 is inserted into the magnet system 12 through the opening in the basket 11. The voice coil carrier 14 is joined essentially at a right angle to a flat diaphragm 15, which in turn is firmly connected to a bead 16. The bead 16 is fastened at its edge away from the flat diaphragm 15 to the outer rim area of the basket 11.

Another bead 17 is again provided as a centering device; in turn, it is fastened solidly to the seam between the voice coil carrier 14 and the flat diaphragm 15, on the one hand, and through a spacer 19 to the basket 11, on the other hand. When used in a flat diaphragm loudspeaker, therefore, the bead mount 18 is designed so that the required height spacing between the two oscillating-system mounts (beads) is again adhered to. It is preferred here (as shown below) for the spacing mount to be made as an inverse cone diaphragm.

The sample embodiment according to FIG. 4 is modified with respect to the sample embodiment shown in FIG. 3 by the fact that a wedge-shaped support structure 20 is provided instead of the bead mount 18, which also serves to hold the bead, so that a bead mount is inherently formed. To this end, for example, the bead 17 is cemented to the support structure 20, which in turn is fastened by cementing to the bottom of the flat diaphragm 15, for example. The additional bead 17 in this case is again bent opposite to the bead 16. All of the beads can be designed normally or inverted.

The sample embodiment according to FIG. 5 proceeds from the embodiment according to FIG. 3, with a multiple bead design being used as a centering device. The basket 11 in this case has two internal steps for fastening two additional beads 21 and 22. The bead 21, which is placed closer to the flat diaphragm 15, is connected to the outer end of a bead mount 23, which in turn is fastened to the voice coil carrier 14 in the area of the seam between it and the flat diaphragm 15. On the other hand, somewhat farther away from the flat diaphragm 15, the bead 22 is then connected to one end of a bead mount 24, which is likewise fastened to the voice coil carrier 14 in the area of the bead mount 23.

Depending on the particular materials used, the fastening here can be accomplished in different ways, for example by cementing, welding, or soldering. Furthermore, instead of the step-like design of the basket 11, the two ends of the additional beads 21 and 22 facing the basket 11 can also be separated from one another by an appropriate spacer profile. The inclusion of an additional bead in the function of the centering device increases the available mechanical damping. Thus, the mechanical damping of the overall oscillating system can be further increased by including additional bead suspensions. The number of additional beads here depends in particular on the necessary magnitude of the oscillating mass and the efficiency resulting therefrom.

The embodiment illustrated in FIG. 6 is modified with respect to the embodiment shown in FIG. 1 in that a specially designed bead 25 is used instead of the bead 8.

FIG. 7 compares the two beads 8 and 25 with one another. The bead 8 used in FIG. 1 has constant thickness over the entire radial extent, i.e. a constant vertical extent in the radial direction. On the other hand, the modified bead 25 is tapered down in the area of the central bend 26 and is thickened in the transitional regions 27 from the central bend to the edge areas.

If the bead and/or the bead design that performs the centering function is specially shaped geometrically (as shown, for example), then both the damping curve and the stiffness can be modulated and optimized across the diaphragm excursion.

The embodiment of a loudspeaker according to the invention shown in FIG. 8 is again obtained proceeding from the arrangement shown in FIG. 3. However the arrangement has been modified in that instead of the magnet system 12, a magnet system 28 is now used that is not behind the basket 11 viewed from the flat diaphragm 15, as shown in FIG. 3, but is in front of the basket 11, toward the flat diaphragm. Corresponding to this, a shorter voice coil carrier 29 is used instead of the voice coil carrier 14.

In addition, a support structure 30 is provided that has a wedge-shaped design and is introduced in the angle formed by the flat diaphragm 15 and the bead mount 18 by joining it on the one hand to the flat diaphragm 15 over its entire surface, for example by cementing, and joining it on the other hand to the section of the additional bead 17 also fastened to the bead mount 18, on its opposite face, for example likewise by cementing. Depending on the particular case, the bead mount 18 can also be omitted and the support structure 30 can be used as the bead mount.

In particular, by using an NdFe cup magnet system or an appropriate magnet system with small dimensions, the structural depth of the loudspeaker can be reduced by raising this magnet system without affecting its excursion capability.

### List of Reference Symbols

1 basket

2 magnet system

3 voice Coil

4 voice coil carrier

5 diaphragm

6 bead

7 dust guard dome

8 additional bead

9 bead mount

10 support structure

11 basket

12 magnet system

13 voice coil

14 voice coil carrier

15 flat diaphragm

16 bead

17 additional bead

18 bead mount

19 spacer

20 support structure

21 additional bead

22 additional bead

23 bead mount

24 bead mount

25 bead

26 central bend

27 transition

28 magnet system

29 voice coil carrier

30 support structure

1. Loudspeaker with
a diaphragm (5, 15) that has an edge area and a central area,
a voice coil carrier (4, 14, 29) that is fastened to the diaphragm (5, 15) in its central area,
a voice coil (3, 13) that is wound around the voice coil carrier (4, 14, 29),
a magnet system (2, 12, 28) into which the voice coil carrier (4, 14, 29) and the voice coil (3, 13) are entirely or partially inserted,
a basket (1, 11) that encloses one face of the diaphragm (5, 15) and to which the magnet system (2, 12, 28) is fastened,
an elastic bead (6, 16) that is fastened on the one hand to the edge area of the diaphragm (5, 15) and on the other hand to the basket (1, 11), and
a centering device that is fastened on the one hand to the central area of the diaphragm (5, 15) and on the other hand to the basket (1, 11), characterized in that
the centering device has an additional elastic bead (8, 17, 21, 22, 25) that is fastened directly or indirectly to the basket (1, 11) and to the diaphragm (5, 15).

2. Loudspeaker according to claim 1, characterized in that the additional bead (8, 17, 21, 22, 25) is fastened directly or indirectly by means of a bead mount (9, 18, 23, 24) to the diaphragm (5, 15) and/or to the basket (1, 11).

3. Loudspeaker according to claim 1 or 2, characterized in that a support structure (10, 20, 30) is provided that is placed between the diaphragm (5, 15) and the additional bead (8, 17) and is connected to them directly or indirectly.

4. Loudspeaker according to claim 1 or 2, characterized in that a support structure (10, 20, 30) is provided that is placed between the diaphragm (5, 15) and the bead mount (8, 9, 17, 18, 23, 24) and is connected to them directly or indirectly.

5. Loudspeaker according to claim 3 or 4, characterized in that the support structure (10, 20, 30) consists essentially of honeycomb material.

6. Loudspeaker according to claim 3 or 4, characterized in that the support structure (10, 20, 30) consists essentially of foamed material.

7. Loudspeaker according to claim 3 or 4, characterized in that the support structure (10, 20, 30) consists essentially of diaphragm material.

8. Loudspeaker according to one of claims 2 to 7, characterized in that the diaphragm (15) has an essentially flat design and the support structure (20, 30) and/or the bead mount (9, 18, 23, 24) equalizes the distance of the beads (6, 16, 8, 17, 21, 22, 25) from one another in the direction of oscillation of the diaphragm.

9. Loudspeaker according to claim 7 or 8, characterized in that an inverse cone diaphragm is provided as the bead mount (9, 18, 23, 24).

10. Loudspeaker according to one of claims 2 to 7, characterized in that at least one second additional bead (22) is provided, which is fastened directly or indirectly to the diaphragm (5, 15) and to the basket (1, 11).

11. Loudspeaker according to one of claims 1 to 10, characterized in that at least one additional bead (25) has a semicircular bend and a flat area, with the thickness of the bead being smaller in the area of the bend than in the flat area.

12. Loudspeaker according to one of claims 1 to 11, characterized in that the support structure (20, 30) also serves as a bead mount.

13. Loudspeaker according to one of claims 1 to 11, characterized in that the magnet system (28) is placed on the face of the basket (11) facing the diaphragm (15).
